(19) United States
(12) Patent Application Publication
(10) Pub. No.: US 2025/0266705 A1
(43) Pub. Date: Aug. 21, 2025

(54) METHOD OF SWITCHING CHARGER-CONVERTER INTEGRATED DEVICE

(71) Applicants: Hyundai Motor Company, Seoul (KR); Kia Corporation, Seoul (KR)

(72) Inventors: Jun-Young Lee, Hwaseong-si (KR); Tae-Jong Ha, Hwaseong-si (KR); Chang-Woo Yun, Hwaseong-si (KR); Dae-Woo Lee, Hwaseong-si (KR); Byung-Gu Kang, Hwaseong-si (KR)

(21) Appl. No.: 18/946,012

(22) Filed: Nov. 13, 2024

(30) Foreign Application Priority Data
Feb. 16, 2024 (KR) 10-2024-0022721

(51) Int. Cl. H02J 7/02; H02M 1/00; H02M 3/335

(52) U.S. Cl. CPC H02J 7/02; H02M 1/0058; H02M 3/33569; H02J 2207/20

(57) ABSTRACT

In a method of increasing power conversion efficiency of a charger-converter integrated device, the method can include performing, by a controller, a first switching operation on a primary bridge circuit of the charger-converter integrated device, and performing synchronization, by the controller, by performing a second switching operation on a secondary bridge circuit of the charger-converter integrated device. The synchronization can be achieved by adding a calculated specific value to a second duty cycle of the secondary bridge circuit for obtaining a first duty cycle of the primary bridge circuit.

### CROSS-REFERENCE TO RELATED APPLICATIONS

This application claims the benefit of Korean Patent Application No. 10-2024-0022721, filed on Feb. 16, 2024, which application is hereby incorporated herein by reference.

### TECHNICAL FIELD

The present disclosure relates to a switching technology of a charger-converter integrated device.

### BACKGROUND

In the case of eco-friendly vehicles, a representative example of an energy storage system for storing and using electrical energy is a battery system composed of a battery, a battery management system (BMS), a pre-charge relay assembly (PRA), etc.

Meanwhile, power conversion systems for efficiently converting and using such electrical energy include converters, chargers, etc. Among them, the converter is a power conversion device functioning to convert high voltage direct current (HVDC) power of the battery into 12 V low voltage direct current (LDC) power.

The charger is a charging device mounted inside a vehicle and performs a function of converting AC system power to DC.

Generally, the converter and the charger are integrated and configured as an integrated circuit. However, such an integrated circuit does not consider a root mean square (RMS) current and/or zero voltage switching (ZVS). That is, primary/secondary phases perform only a charger operation, and a secondary duty performs only a converter operation.

Therefore, there is a problem that the power conversion efficiency of the integrated circuit is low because the RMS current is high and zero voltage switching is not achieved.

### SUMMARY

The present disclosure relates to a switching technology of a charger-converter integrated device, and more specifically, to a switching method of improving a root mean square (RMS) current and/or zero voltage switching (ZVS) of a charger-converter integrating device.

An embodiment of the present disclosure can solve the problems noted above and can provide a method of increasing the power conversion efficiency of a charger-converter integrated device.

An embodiment of the present disclosure can provide a method of increasing the power conversion efficiency of a charger-converted integrated device.

A method of switching a charger-converter integrated device can include performing, by a controller, a first switching operation on a primary bridge circuit of the charger-converter integrated device, and performing synchronization, by the controller, by performing a second switching operation on a secondary bridge circuit of the charger-converter integrated device.

The first switching operation or the second switching operation may be a zero voltage switching.

A primary bridge duty for the first switching operation may be a value obtained by adding a specific value to a secondary bridge duty for the second switching operation.

The specific value may be greater than or equal to a preset reference value.

The reference value may be a value obtained by multiplying a square root value of an inductance of an inductor disposed between the primary bridge circuit and the secondary bridge circuit and a capacitance of a parasitic capacitor of the primary bridge circuit by a switching frequency at which switching elements of the primary bridge circuit are turned on and off.

A current used for the zero voltage switching may be a current when energy stored in an inductor disposed between the primary bridge circuit and the secondary bridge circuit is higher than energy stored in a parasitic capacitor of the switching elements of the primary bridge circuit.

A waveform of the current used for the zero voltage switching may have a shape that increases in a slanted stepwise manner in a section between a leading leg of a primary bridge duty and a rising edge of a secondary bridge duty.

A waveform used for the zero voltage switching may have a negative current generated at a time point of a lagging leg of the primary bridge duty.

The energy stored in the inductor may be greater than or equal to a multiple of the energy stored in the parasitic capacitor.

The energy stored in the inductor may be calculated by using a current at the time point required or desired for the zero voltage switching and an inductance of the inductor.

The energy stored in the parasitic capacitor may be calculated by using a differential voltage due to a difference between a parasitic capacitance of a parasitic capacitor and each of neutral points generated at a plurality of pair of switching elements of the primary bridge circuit.

The zero voltage switching in the secondary bridge circuit may be performed by using a magnetization current of a transformer.

A primary bridge circuit and a secondary bridge circuit may be subjected to primary phase control and secondary phase control, respectively, to execute a high voltage battery charging operation mode in which charging power is supplied to a high voltage battery.

A method may include executing, by the controller, a secondary duty for the secondary bridge circuit to maintain a low voltage battery charging operation mode in which charging power is supplied to a low voltage battery, and performing, by the controller, a third switching operation on an auxiliary circuit of the charger-converter integrated device.

According to an embodiment of the present disclosure, it can be possible to increase power conversion efficiency by reducing the RMS current and achieving the ZVS of the charger-converter integrated device.

According to an embodiment of the present disclosure, it can be possible to select the switch with the lower specification by reducing a switching loss.

According to an embodiment of the present disclosure, it can be possible to design the transformer with the lower specification by reducing an RMS and a peak current.

### BRIEF DESCRIPTION OF THE DRAWINGS

FIG. 1 is a block diagram of a charger-converter integrated device according to an embodiment of the present disclosure.

FIG. 2 is a circuit schematic for an example of the charger-converter integrated device shown in FIG. 1, according to an embodiment of the present disclosure.

FIG. 3 is an equivalent circuit diagram equivalently showing a circuit example shown in FIG. 2, according to an embodiment of the present disclosure.

FIG. 4 is a block diagram of a detailed configuration of a controller shown in FIG. 1, according to an embodiment of the present disclosure.

FIG. 5 is a flowchart showing a synchronization process according to an embodiment of the present disclosure.

FIG. 6 is a waveform diagram showing a switching method according to an embodiment of the present disclosure.

FIG. 7 is a conceptual diagram showing that a specific value is calculated for zero voltage switching according to an embodiment of the present disclosure.

### DETAILED DESCRIPTION OF ILLUSTRATIVE EMBODIMENTS

The above-described features and advantages will be described below in detail with reference to the accompanying drawings illustrating example embodiments, and thus those skilled in the art to which the present disclosure pertains can carry out the technical spirit of the present disclosure. In describing example embodiments of the present disclosure, when it is determined that a detailed description of known technology related to the present disclosure may unnecessarily obscure the gist of the present disclosure, a detailed description thereof can be omitted.

Hereinafter, example embodiments according to the present disclosure will be described in detail with reference to the accompanying drawings. In the drawings, same reference numerals can be used to denote same or similar components.

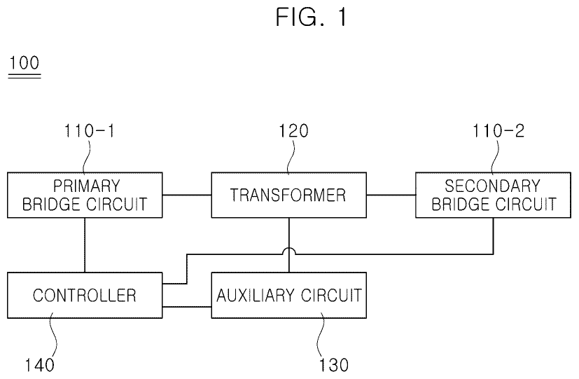

FIG. 1 is a block diagram of a configuration of a charger-converter integrated device 100 according to an embodiment of the present disclosure. Referring to FIG. 1, the charger-converter integrated device 100 may include a primary bridge circuit 110-1, a transformer 120, a secondary bridge circuit 110-2, an auxiliary circuit 130, a controller 140, etc., any combination of or all of which may be in plural or may include plural components thereof.

The primary bridge circuit 110-1 can perform a function of smoothing DC power and converting output DC link power into AC power. A power factor correction (PFC) circuit (not shown) may be configured in front of the primary bridge circuit 110-1. The PFC circuit can function to convert AC power from which interfering electromagnetic waves have been removed into DC power and reduce power loss that occurs in this conversion process.

The PFC circuit can have an inverter configuration for converting AC power supplied from a power grid (not shown) into DC power and a configuration for improving a power factor. That is, the PFC circuit may be an inverter type PFC.

In the case of fast charging, high voltage DC power may be input. In this case, the PFC circuit may operate by only a configuration for improving the power factor.

The transformer 120 can function to change the AC power output from the primary bridge circuit 110-1 to increase or decrease.

The secondary bridge circuit 110-2 can perform a function of converting the changed AC power from the transformer 120 into DC power for charging and supplying the converted DC power for charging to a high voltage battery (not shown) (e.g., battery for powering motors of an electric vehicle).

The auxiliary circuit 130 can perform a function of converting the AC power changed from the transformer 120 into DC power for charging and supplying the converted DC power for charging to a low voltage battery (not shown) (e.g., 12V battery for powering processors/controllers, sensors, and accessories of an electric vehicle). That is, the auxiliary circuit 130 can convert the AC power changed from the charged DC power of the high voltage battery through the secondary bridge circuit 110-2 and the transformer 120 into DC power and supply the converted DC power to an auxiliary battery.

The controller 140 can perform switching by turning on/off switching elements configured in the primary bridge circuit 110-1, the secondary bridge circuit 110-2, and the auxiliary circuit 130. The controller 140 may be connected to a higher level controller (not shown) to receive data from the higher level controller or transmit data to the higher level controller. The higher level controller may be an electric control unit (ECU), a hybrid control unit (HCU), a vehicle control unit (VCU), etc.

In particular, the controller 140 can synchronize a primary bridge duty with a secondary bridge duty. That is, a difference is that a primary bridge duty D1 can be additionally synchronized with a secondary bridge duty D2 and an alpha value can be added to the primary bridge duty D1.

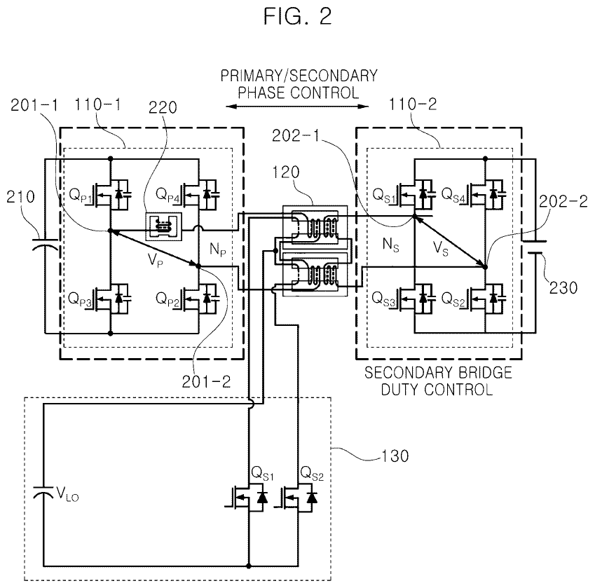

FIG. 2 is a circuit example of the charger-converter integrated device 100 shown in FIG. 1. Referring to FIG. 2, the primary bridge circuit 110-1 can be connected to a DC-link power supply 210 and include 1-1 to 1-4 switching elements Q_{P1} to Q_{P4}. That is, the 1-1 and 1-3 switching elements Q_{P1} and Q_{P3} can be disposed in series at a set, selected, or predetermined interval, and the 1-2 and 1-4 switching elements Q_{P2} and Q_{P4} can be disposed in series at a set, selected, or predetermined interval. The 1-1 and 1-3 switching elements Q_{P1} and Q_{P3} can be disposed in parallel to the 1-2 and 1-4 switching elements Q_{P2} and Q_{P4}.

A 1-1 neutral point 201-1 of the 1-1 switching element Q_{P1} and the 1-3 switching element Q_{P3} and a primary winding N_{P} of the transformer 120 can be connected by an electric wire, and a 1-2 neutral point 201-2 of the 1-2 switching element Q_{P2} and the 1-4 switching element Q_{P4} and the primary winding N_{P} of the transformer 120 can be connected by an electric wire.

A transformer element 220 may be configured between the 1-1 neutral point 201-1 of the 1-1 switching element Q_{P1} and the 1-3 switching element Q_{P3} and the primary winding N_{P} of the transformer 120. A primary voltage V_{P} according to a difference between the 1-1 neutral point 201-1 and the 1-2 neutral point 201-2 can be generated.

The secondary bridge circuit 110-2 can be connected to a secondary winding N_{S} of the transformer 120 and can include 2-1 to 2-4 switching elements Q_{S1} to Q_{S4}. That is, the 2-1 and 2-3 switching elements Q_{S1} and Q_{S3} can be disposed in series at a set, selected, or predetermined interval, and the 2-2 and 2-4 switching elements Q_{S2} and Q_{S4} can be disposed in series at a set, selected, or predetermined interval. The 2-1 and 2-3 switching elements Q_{S1} and Q_{S3} can be disposed in parallel to the 2-2 and 2-4 switching elements Q_{S2} and Q_{S4}.

A 2-1 neutral point 202-1 of the 2-1 switching element Q_{S1} and the 2-3 switching element Q_{S3} and a secondary winding N_{S} of the transformer 120 can be connected by an electric wire, and a 2-2 neutral point 202-2 of the 2-2 switching element Q_{S2} and the 2-4 switching element Q_{S4} and the secondary winding N_{S} of the transformer 120 can be connected by an electric wire. A secondary voltage V_{S} according to a difference between the 2-1 neutral point 201-1 and the 2-2 neutral point 201-2 can be generated.

The auxiliary circuit 130 can include a capacitor V_{LO}, the 2-1 switching element Q_{S1}, and the 2-2 switching element Q_{S2} in parallel.

The switching elements Q_{P1} to Q_{P4} and Q_{S1} to Q_{S4} may mainly use insulated gate bipolar mode transistors (IGBT), but are not limited thereto, and may use a semiconductor switching element such as a field effect transistor (FET), a metal oxide semiconductor FET (MOSFET), and a power rectifier diode, a thyristor, a gate turn-off (GTO) thyristor, a triode for alternating current (TRIAC), a silicon controlled rectifier (SCR), an integrated circuit (IC), etc., for example.

In particular, the semiconductor switching device may use bipolar or power MOSFET elements, etc. The power MOSFET elements can operate at high voltage and high current and unlike general MOSFETs, can have a double-diffused metal oxide semiconductor (DMOS) structure.

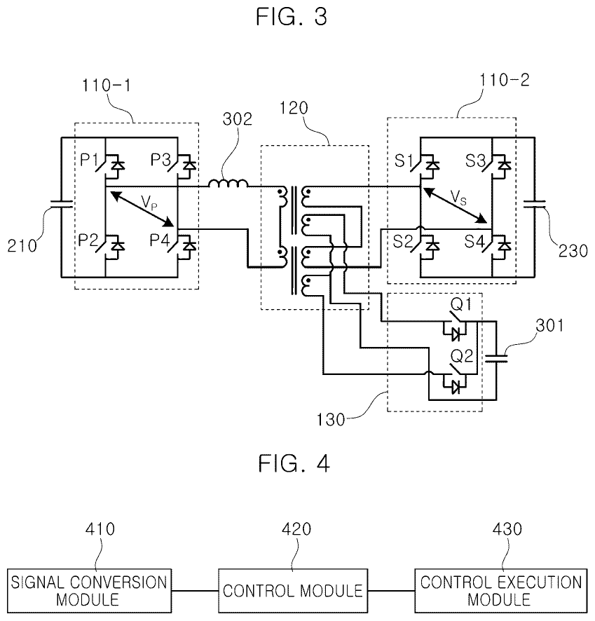

FIG. 3 is an equivalent circuit diagram equivalently showing a circuit example shown in FIG. 2. Referring to FIG. 3, the switching elements Q_{P1} to Q_{P4} and Q_{S1} to Q_{S4} shown in FIG. 2 can be replaced with switching elements P1 to P4, S1 to S4, and Q1 and Q2. The primary bridge circuit 110-1 can be composed of the 1-1 to 1-4 switching elements P1 to P4, and the secondary bridge circuit 110-2 can be composed of the 2-1 to 2-4 switching elements S1 to S4. The secondary bridge circuit 110-2 can supply charging power to a high voltage battery 230.

An inductor 302 can be configured between the primary bridge circuit 110-1 and the primary winding of the transformer 120.

The high voltage battery 230 can include battery cells (not shown) configured in series and/or parallel, and the battery cells may be high voltage battery cells for an electric vehicle, such as nickel metal battery cells, lithium ion battery cells, lithium polymer battery cells, lithium sulfur battery cells, sodium sulfur battery cells, and all-solid-state battery cells, for example. A voltage of the high voltage battery 230 may be about 800 V, for example.

In addition, the auxiliary circuit 130 can be composed of the 3-1 and 3-2 switching elements Q1 and Q2 when the 2-1 and 2-2 switching elements Q_{S1} and Q_{S2} shown in FIG. 2 are converted into an equivalent circuit. The auxiliary circuit 130 can perform a function of supplying charging power to a low voltage battery 301. A voltage of the low voltage battery 301 may be about 12 V. That is, the auxiliary circuit 130 receives output power from the high voltage battery 230 to reduce the charging power through the transformer 120 and supplies the reduced charging power to the low voltage battery 301.

FIG. 4 is a block diagram of a detailed configuration of the controller 140 shown in FIG. 1. Referring to FIG. 4, the controller 140 may include a signal conversion module 410, a control module 420, a control execution module 430, etc., any combination of or all of which may be in plural or may include plural components thereof. The signal conversion module 410 can perform a function of receiving analog input/output signals from the primary bridge circuit 110-1, the secondary bridge circuit 110-2, and the auxiliary circuit 130 and converting the analog input/output signals into digital input/output signals. Therefore, the signal conversion module 410 may include an analog-digital converter (ADC), etc., for example.

The control module 420 can perform a function of synchronizing the first bridge duty and the second bridge duty using the input/output signals. In particular, the control module 420 can generate a control signal for controlling the primary bridge circuit 110-1, the secondary bridge circuit 110-2, and the auxiliary circuit 130 by additionally synchronizing the primary bridge duty D1 with the secondary bridge duty D2 and adding a specific value α to the primary bridge duty D1. To this end, the control module 420 may include a microprocessor, a microcomputer, a memory, etc., any combination of or all of which may be in plural or may include plural components thereof, for example.

The control execution module 430 can perform a function of controlling the switching of the switching elements configured in the primary bridge circuit 110-1, the secondary bridge circuit 110-2, and the auxiliary circuit 130 by receiving the control signal from the control module 420. Generally, the switching control of the switching elements can use a pulse width modulation (PWM) method, but is not limited thereto, and may use a pulse frequency modulation (PFM) method, etc., for example. The control execution module 430 may include a microprocessor, an IC, a clock generator, an electronic circuit, etc., any combination of or all of which may be in plural or may include plural components thereof, for example.

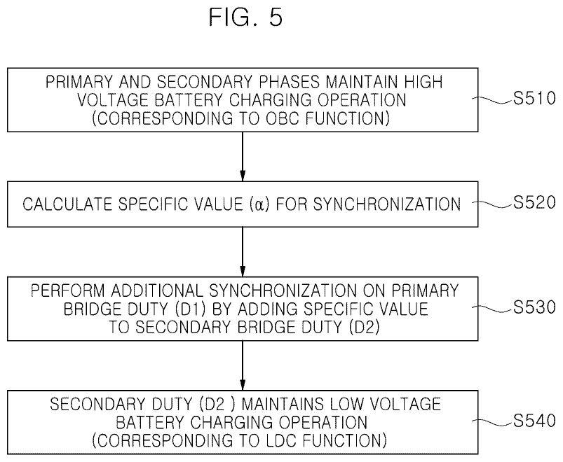

FIG. 5 is a flowchart showing a synchronization process according to an embodiment of the present disclosure. Referring to FIG. 5, the primary bridge circuit 110-1 and the secondary bridge circuit 110-2 can be subjected to primary phase control and secondary phase control by the controller 140, respectively (operation S510). That is, the primary phase control and the secondary phase control can be methods of controlling power based on the phase between the primary and secondary switching elements.

Such phase control can maintain a high voltage battery charging operation mode in which charging power can be supplied to the high voltage battery 230. That is, the phase control can perform an on-board charger (OBC) function.

To synchronize the primary bridge duty D1 for the primary bridge circuit 110-1 with the secondary bridge duty D2 for the secondary bridge circuit 110-2, the controller 140 can calculate the specific value α (operation S520). When the duty is synchronized, root mean square (RMS) currents and peaks can be reduced.

The controller 140 can perform additional synchronization of the primary bridge duty D1 with the secondary bridge duty D2 (operation S530).

When the high voltage battery 230 is fully charged or charged to a target value specified by a user, the secondary duty D2 for the secondary bridge circuit 110-2 can maintain a low voltage battery charging operation mode in which charging power is supplied to the low voltage battery 301. That is, a low direct current direct current converter (LDC) function can be performed.

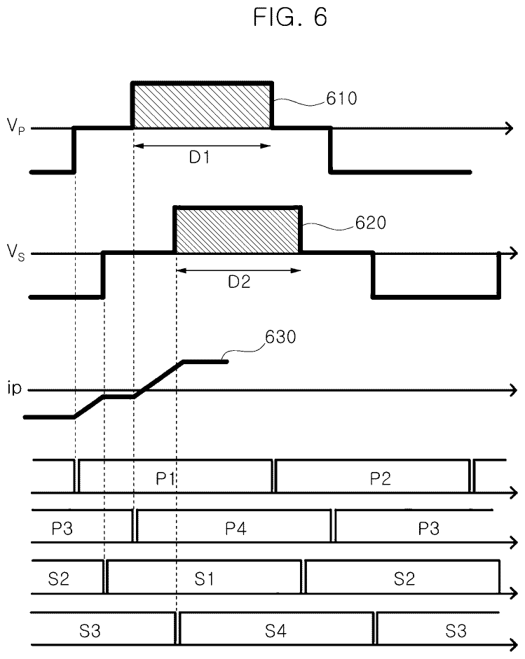

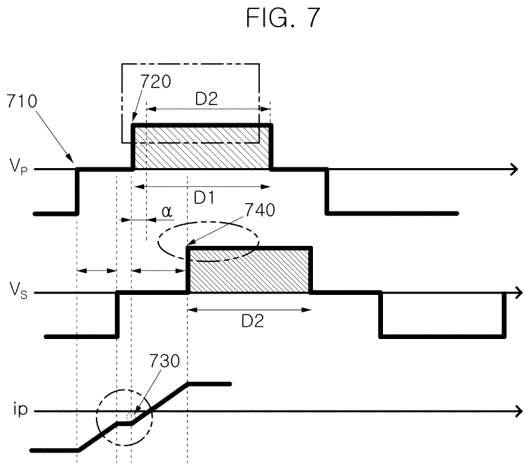

FIG. 6 is a waveform diagram showing a switching method according to an embodiment of the present disclosure. Referring to FIG. 6, duty-synchronized forms can reduce RMS currents and peaks compared to non-duty-synchronized forms. This can be because, due to the characteristics of a dual active bridge (DAB) converter shown in FIGS. 2 and 3, an excessive voltage can be not applied to the inductor 302 as the waveforms of the transformer 120 are synchronized. In addition, this can be because an excessive current slope can be not formed.

The primary bridge duty D1 on a waveform 610 of the primary voltage V_{P} can be additionally synchronized with the secondary bridge duty D2 on a waveform 620 of the secondary voltage V_{S}. Therefore, it can be possible to prevent the generation of a peak current falling downward on the waveform of a current ip generated in the primary bridge circuit 110-1. That is, a waveform 630 of the current ip can increase stepwise in a set, selected, or predetermined section.

In FIGS. 6, P1 to P4 represent switching states of the switching elements configured in the primary bridge circuit 110-1, and S1 to S4 represent switching states of the switching elements configured in the secondary bridge circuit 110-2.

FIG. 7 is a conceptual diagram showing that a specific value α can be calculated for zero voltage switching (ZVS) according to an embodiment of the present disclosure. Referring to FIG. 7, for the ZVS of all switching elements configured in the primary bridge circuit 110-1 and the secondary bridge circuit 110-2, the primary bridge duty D1 can have the specific value α added to the secondary bridge duty D2. That is, for example, D1=D2+α.

When there is no such specific value α added, the ZVS does not occur due to lack of the current ip at a lagging leg time point 720 of the primary voltage V_{P} generated on the primary bridge circuit 110-1. A leading leg 710 is present before the lagging leg time point.

Conversely, when such a specific value α is added, a negative current can be generated at the lagging leg time point 720 of the primary voltage V_{P} to enable the ZVS. That is, such a specific value can extend a front end of the primary bridge duty D1 forward by a set, selected, or predetermined width. Therefore, D1=D2+specific value α.

A current I_{ZVS} at the time point 730 required for ZVS can be represented by Equation 1 below.

$${I}_{ZVS} = ( {V}_{p} / L ) ( - α / 2 ) / 2 π f \qquad [ Equation 1 ]$$

Here, V_{P} denotes a voltage according to the difference between the 1-1 neutral point 201-1 and the 1-2 neutral point 201-2, L denotes an inductance, and f denotes a switching frequency at which the switching elements of the primary bridge circuit 110-1 are turned on and off.

The current ip required for ZVS can be a value at which a parasitic capacitor voltage may be fully discharged by energy stored in the inductor 302 higher than energy stored in the parasitic capacitor of the switching element of the primary bridge circuit 110-1.

This is represented by Equation 2 below.

$$\frac{1}{2} {LI}_{ZVS}^{2} \geq 2 \times {CV}_{P}^{2} \qquad [ Equation 2 ]$$

Here, C denotes a parasitic capacitance of the switching element.

By rewriting Equation 2, the alpha value α may be set as in Equation 3 below.

$$α \geq π f \sqrt{32 LC} \qquad [ Equation 3 ]$$

Therefore, the ZVS can be achieved by selecting the alpha value to be more than πf\sqrt{32LC}, which can be a reference value.

Additionally, in the secondary bridge circuit 110-2, the secondary voltage V_{S} can achieve the ZVS at a magnetization current of the transformer 120. That is, in the case of the secondary bridge circuit 110-2 due to a topological structure, the ZVS may be performed by using a structure in which a magnetizing inductance of the transformer 120 is directly shown.

As a result, using an embodiment of the present disclosure, the ZVS can be achieved in all switching elements configured in the primary bridge circuit 110-1 and the secondary bridge circuit 110-2.

The waveform of the current ip can have a shape that increases in a slanted stepwise manner in a section between the leading leg 710 of the primary bridge duty D1 and a rising edge 740 of the secondary bridge duty D2.

In addition, the operations of the method or algorithm described in relation to the example embodiments disclosed herein may be implemented in the form of program commands that may be executed through various computer devices such as a microprocessor, a processor, and a CPU and stored in a computer-readable medium. The computer-readable medium may include program (command) codes, data files, data structures, etc., alone or in combination.

What is claimed is:

1. A method of switching a charger-converter integrated device, the method comprising:
performing, by a controller, a first switching operation on a primary bridge circuit of the charger-converter integrated device; and
performing synchronization, by the controller, by performing a second switching operation on a secondary bridge circuit of the charger-converter integrated device.

2. The method of claim 1, wherein the first switching operation or the second switching operation is a zero voltage switching.

3. The method of claim 2, wherein a primary bridge duty for the first switching operation is a new value obtained by adding a specific value to a secondary bridge duty for the second switching operation.

4. The method of claim 3, wherein the specific value is greater than or equal to a preset reference value.

5. The method of claim 4, wherein the preset reference value is obtained by multiplying a square root value of an inductance of an inductor disposed between the primary bridge circuit and the secondary bridge circuit and a capacitance of a parasitic capacitor of the primary bridge circuit by a switching frequency at which switching elements of the primary bridge circuit are turned on and off.

6. The method of claim 2, wherein a current required for the zero voltage switching is when inductor energy stored in an inductor disposed between the primary bridge circuit and the secondary bridge circuit is higher than capacitor energy stored in a parasitic capacitor of switching elements of the primary bridge circuit.

7. The method of claim 6, wherein a waveform of the current required for the zero voltage switching has a shape that increases in a slanted stepwise manner in a section between a leading leg of a primary bridge duty and a rising edge of a secondary bridge duty.

8. The method of claim 6, wherein a waveform required for the zero voltage switching has a negative current generated at a time point of a lagging leg of a primary bridge duty.

9. The method of claim 6, wherein the inductor energy stored in the inductor is greater than or equal to a multiple of the capacitor energy stored in the parasitic capacitor.

10. The method of claim 9, wherein the inductor energy stored in the inductor is calculated by using the current at a time point required for the zero voltage switching and an inductance of the inductor.

11. The method of claim 9, wherein the capacitor energy stored in the parasitic capacitor is calculated by using a differential voltage due to a difference between a parasitic capacitance of the parasitic capacitor and each of neutral points generated at a plurality of pair of switching elements of the primary bridge circuit.

12. The method of claim 2, wherein the zero voltage switching in the secondary bridge circuit is performed by using a magnetization current of a transformer.

13. The method of claim 1, wherein a primary bridge circuit and a secondary bridge circuit are subjected to primary phase control and secondary phase control, respectively, to execute a high voltage battery charging operation mode in which charging power is supplied to a high voltage battery.

14. The method of claim 1, further comprising:
executing, by the controller, a secondary duty for the secondary bridge circuit to maintain a low voltage battery charging operation mode in which charging power is supplied to a low voltage battery; and
performing, by the controller, a third switching operation on an auxiliary circuit of the charger-converter integrated device.

15. A method of switching a charger-converter integrated device, the method comprising:
determining a specific value greater than or equal to a preset reference value, wherein the preset reference value is obtained by multiplying a square root value of an inductance of an inductor and a capacitance of a parasitic capacitor of a primary bridge circuit by a switching frequency at which primary bridge switches of the primary bridge circuit are turned on and off, wherein the inductor is coupled between the primary bridge circuit and a secondary bridge circuit;
setting a primary duty cycle for a first switching operation of the primary bridge switches of the primary bridge circuit to be a new value obtained by adding the specific value to a secondary duty cycle for a second switching operation of secondary bridge switches of the secondary bridge circuit;
performing the first switching operation on the primary bridge circuit at the primary duty cycle using the new value; and
performing the second switching operation on the secondary bridge circuit at the secondary duty cycle.

16. The method of claim 15, wherein the first switching operation is a zero voltage switching.

17. The method of claim 15, wherein the second switching operation is a zero voltage switching.

18. A system for switching a charger-converter integrated device, the system comprising:
a primary bridge circuit including primary bridge switches;
a secondary bridge circuit including secondary bridge switches;
a transformer coupled between the primary bridge circuit and the secondary bridge circuit;
an inductor coupled between the primary bridge circuit and the transformer;
one or more processors; and
a storage medium storing computer-readable instructions that, when executed by the one or more processors, enable the one or more processors to:
determining a specific value greater than or equal to a preset reference value, wherein the preset reference value is obtained by multiplying a square root value of an inductance of the inductor and a capacitance of a parasitic capacitor of the primary bridge circuit by a switching frequency at which the primary bridge switches of the primary bridge circuit are turned on and off,
setting a primary duty cycle for a first switching operation of the primary bridge switches of the primary bridge circuit to be a new value obtained by adding the specific value to a secondary duty cycle for a second switching operation of the secondary bridge switches of the secondary bridge circuit,
performing the first switching operation on the primary bridge circuit at the primary duty cycle, and performing the second switching operation on the secondary bridge circuit at the secondary duty cycle.

19. The system of claim 18, wherein the primary bridge switches are configured such that a primary voltage is a first difference between a first primary neutral point and a second primary neutral point among primary bridge circuit connection points of the primary bridge switches;
wherein the secondary bridge switches are configured such that a secondary voltage is a second difference between a first secondary neutral point and a second secondary neutral point among secondary bridge circuit connection points of the secondary bridge switches; and
wherein the first switching operation is a zero voltage switching for the primary voltage.

20. The system of claim 18, wherein the primary bridge switches are configured such that a primary voltage is a first difference between a first primary neutral point and a second primary neutral point among primary bridge circuit connection points of the primary bridge switches;
wherein the secondary bridge switches are configured such that a secondary voltage is a second difference between a first secondary neutral point and a second secondary neutral point among secondary bridge circuit connection points of the secondary bridge switches; and
wherein the second switching operation is a zero voltage switching for the secondary voltage.
